(19) United States
(12) Patent Application Publication
(10) Pub. No.: US 2014/0149901 A1
(43) Pub. Date: May 29, 2014

(54) Gesture Input to Group and Control Items

(71) Applicant: MOTOROLA MOBILITY LLC, Libertyville, IL (US)

(72) Inventor: James M. Hunter, San Jo, CA (US)

(73) Assignee: Motorola Mobility LLC, Libertyville, IL (US)

(21) Appl. No.: 13/687,181

(22) Filed: Nov. 28, 2012

(51) Int. Cl. G06F 3/01

(52) U.S. Cl. CPC G06F 3/017
USPC 715/765

(57) ABSTRACT

In one embodiment, a method receives a gesture via a touchscreen of an electronic device. The touchscreen displays a set of objects that are used to control a set of controllable devices. The method then determines the gesture is a command to group a plurality of objects together and joins the plurality of objects as a single group. The plurality of objects correspond to a plurality of controllable devices. A control to apply to the single group is determined in response to receiving the gesture where the control is applied to the plurality of controllable devices to cause the plurality of controllable devices to perform a function together.

### BACKGROUND

A user may automatically control controllable devices using input devices. For example, the user may control the dimming of different lights, the unlocking or locking of doors, the playing of media programs, etc. using the input device. In one example, the input device may display a user interface that includes a plurality of objects. Each object may represent a controllable device that a user can control automatically.

If a user wants to control a first controllable device, the user would locate a first object on the user interface that corresponds to the first controllable device. For example, the first object may be an icon that is displayed on the user interface. The user would then select the first object and apply a control command that the user desires. For example, a user may turn off a living room light.

If the user wants to perform a subsequent command with a second controllable device, the user would locate a second object on the user interface for the second controllable device. The user would then select the second object and apply the desired control command for the second object. Then, the command is applied to the second controllable device. For example, the user may turn off a bedroom room light.

Although the user can automatically control multiple controllable devices, it may be burdensome for the user to serially control multiple controllable devices. That is, for each controllable device, the user must select an object corresponding to each controllable device and individually apply the desired commands via the objects.

### BRIEF DESCRIPTION OF THE DRAWINGS

FIG. 1 depicts a simplified system for grouping objects for control using multi-touch gestures according to one embodiment.

FIG. 2A shows an example where a user has used a multi-touch gesture to indicate two objects to group together according to one embodiment.

FIG. 2B shows a result of performing the object gesture according to one embodiment.

FIG. 2C shows an example where a user has used a gesture to move a first object into an existing group according to one embodiment.

FIG. 2D shows a result of performing the object gesture of FIG. 2C according to one embodiment.

FIG. 3A shows an example where a user has used a multi-touch gesture to indicate an area in which objects within the area should be grouped together according to one embodiment.

FIG. 3B depicts an example of a grouping that is created based on the area gesture received in FIG. 3A according to one embodiment.

FIG. 3C shows an example where a user has used a gesture to move a first object into an existing group using the area gesture according to one embodiment.

FIG. 3D shows a result of performing the object gesture of FIG. 3C according to one embodiment.

FIG. 4A shows an example of system before forming group according to one embodiment.

FIG. 4B depicts an example for controlling devices when a group is formed according to one embodiment.

FIG. 5 depicts a simplified flowchart for combining functions according to one embodiment.

FIG. 6 depicts a simplified flowchart of a method for performing grouping using tiers according to one embodiment.

FIG. 7A shows an example of using a pinching gesture to move an object from a first group to a second group according to one embodiment.

FIG. 7B shows an example of a de-pinch gesture according to one embodiment.

FIG. 7C shows a result of the de-pinch gesture according to one embodiment.

### DETAILED DESCRIPTION

Described herein are techniques for applying gestures to group objects. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

In one embodiment, a method receives a gesture via a touchscreen of an electronic device. The touchscreen displays a set of objects that are used to control a set of controllable devices. The method then determines the gesture is a command to group a plurality of objects together and joins the plurality of objects as a single group. The plurality of objects corresponds to a plurality of controllable devices. A control to apply to the single group is determined in response to receiving the gesture where the control is applied to the plurality of controllable devices to cause the plurality of controllable devices to perform a function together.

In one embodiment, a non-transitory computer-readable storage medium is provided that contains instructions that, when executed, control a computer system to be configured for: receiving a gesture via a touchscreen of an electronic device, the touchscreen displaying a set of objects that are used to control a set of controllable devices; determining the gesture is a command to group a plurality of objects together; joining the plurality of objects as a single group, wherein the plurality of objects correspond to a plurality of controllable devices; and associating a control to apply to the single group in response to receiving the gesture, wherein the control is applied to the plurality of controllable devices to cause the plurality of controllable devices to perform a function together.

In one embodiment, a system is provided comprising: a plurality of controllable devices, wherein the plurality of controllable devices correspond to a set of objects that are used to control the plurality of controllable devices via a touchscreen of an input device; and a control device coupled to the plurality of controllable devices, wherein: a set of controllable devices are grouped together into a single group based on a gesture received via the touchscreen the input device, the touchscreen displaying the set of objects, the control device receives a control to apply to the single group in response to the gesture, and the control device applies the control to the plurality of controllable devices to cause the plurality of controllable devices to perform a function together.

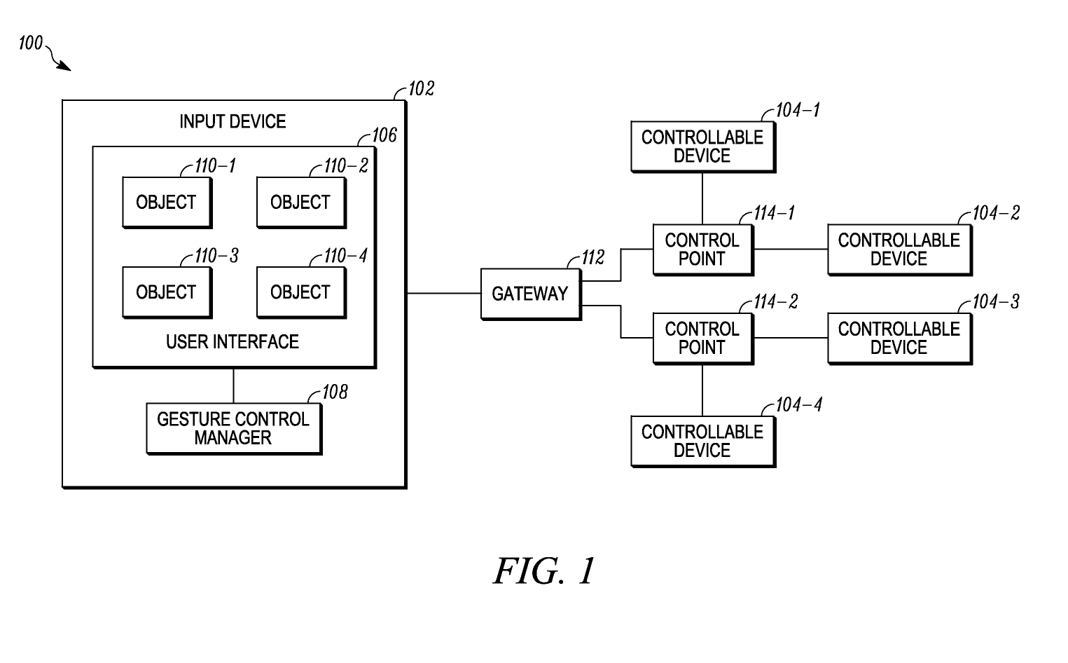

FIG. 1 depicts a simplified system 100 for grouping objects for control using multi-touch gestures according to one embodiment. System 100 includes an input device 102 that a user can use to control controllable devices 104. For example, input device 102 may be an electronic device and controllable devices 104 may be items in a location, such as a user's home. Examples of controllable devices 104 include lights, media players, locks, thermostats, and various other devices that can be automatically controlled. Input devices 102 include cellular phones, smartphones, tablet devices, laptop computers, and other computing devices

Input device 102 includes a user interface 106 and a gesture control manager 108. User interface 106 displays objects 110-1-110-4 that correspond to controllable devices 104-1-104-4, respectively. User interface 106 may display each object 110 as an icon or other graphical representation. A user may use an object 110-1 to automatically control controllable device 104-1. Likewise, objects 110-2, 110-3, and 110-4 may be used to control controllable devices 104-2, 104-3, and 104-4, respectively. It will be understood that although a 1:1 relationship of objects 110 to controllable devices 104 is described, a single object 110 may control multiple controllable devices 104. In one embodiment, input device 102 communicates with a gateway 112 to send commands to control controllable devices 104. Gateway 112 may also communicate with a number of control points 114-1-114-2 that may be connected to controllable devices 104. Although this system configuration is described, it will be understood that other systems for distributing commands to controllable devices 104 may be used, such as a single gateway or control point may be used.

Particular embodiments allow a user to use a gesture, such as a multi-touch gesture, to combine objects 110 into a group. In one embodiment, a gesture control manager 108 detects a multi-touch gesture on user interface 106 and groups objects 110 together accordingly. When combined into a group, a control is associated with all objects 110 in the group. For example, input device 102 may control all objects 110 in the group where a control command is applied to the group. In another example, when an object 110 is added to a group, a control is automatically applied to object 110. For example, a controllable device 104 corresponding to object 110 is automatically controlled to start playing a media program. The various scenarios will be described in more detail below. Also, other input devices 102 (not shown) may control the group where all control commands are applied to controllable devices 104 corresponding to objects 110 in the group.

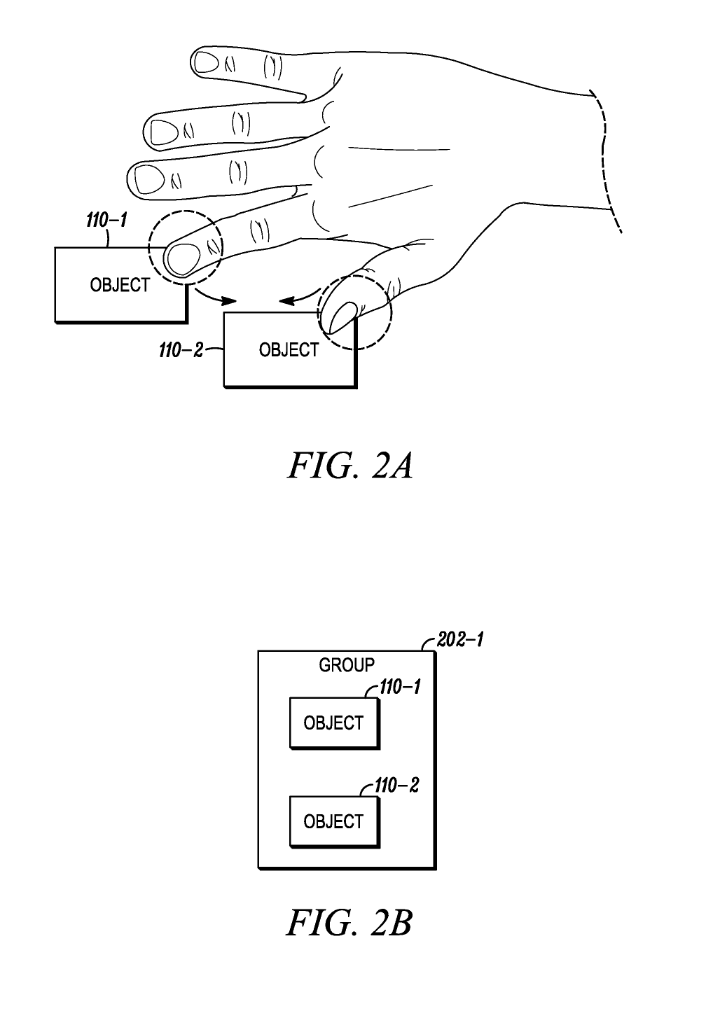

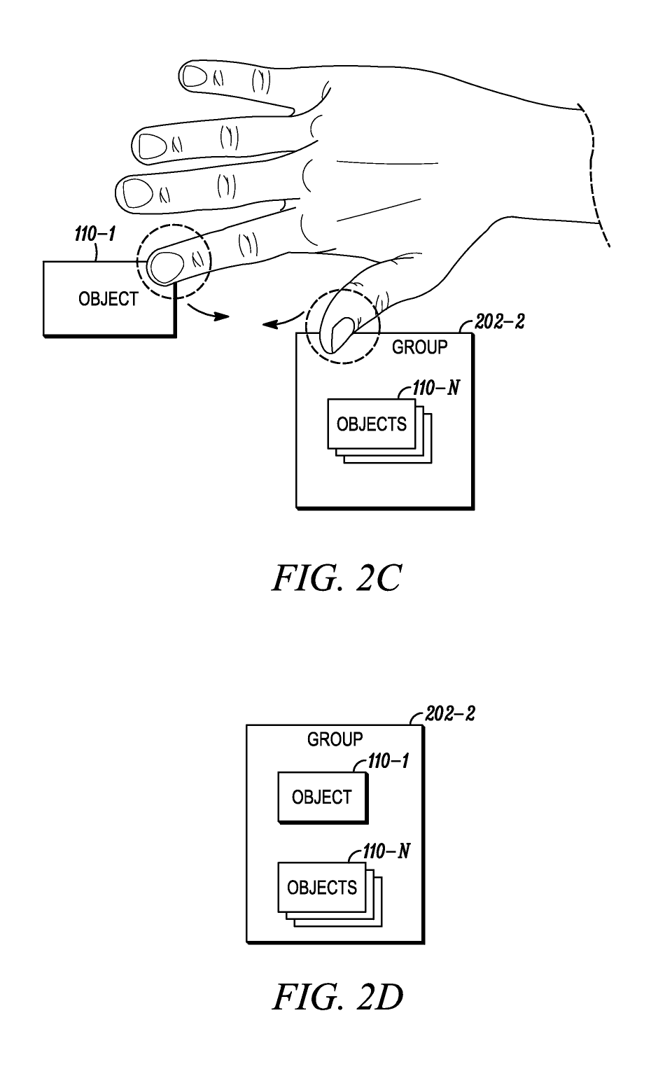

FIGS. 2A and 2B show an example of forming a group using an “object gesture” according to one embodiment. FIG. 2A shows an example where a user has used a multi-touch gesture to indicate two objects 110-1 and 110-2 to group together according to one embodiment. As shown, a first object 110-1 and a second object 110-2 are being touched by a user's two fingers. In this case, the user's fingers touch both objects 110-1 and 110-2. Gesture control manager 108 may detect the touch using known methods. Also, although fingers are discussed, a user may use other methods for touching user interface 104, such as by using a stylus.

A user may then make a gesture that indicates a desire to group the two objects 110-1 and 110-2 together. For example, the user may make a “pinching” gesture to move both objects 110-1 and 110-2 together such that they move towards each other. In one example, gesture control manager 108 determines that a pinching gesture has been performed when objects 110-1 and 110-2 overlap or touch. However, objects 110-1 and 110-2 do not need to touch for gesture control manager 108 to determine a pinching gesture. For example, gesture control manager 108 may analyze a speed of pinching and determine a pinching gesture has been performed when the speed of movement of objects 110-1 and 110-2 is above a threshold. Other ways of forming the group may be used. For example, the user may touch both objects 110-1 and 110-2 and then indicate the desire for grouping by pressing a separate button or icon to indicate the desire to create a group.

FIG. 2B shows a result of performing the object gesture according to one embodiment. As shown, objects 110-1 and 110-2 have been grouped together in a group 202-1. In one embodiment, group 202-1 may be shown with a border that is visible. In other examples, objects 110-1 and 110-2 do not need to be grouped together within a defined group object. Rather, other indications may be used, such as placing objects 110-1 and 110-2 next to each other or by shading objects 110-1-110-3 with the same color.

After forming group 202-1, gesture control manager 108 associates a control for the group that applies to all objects 110 of the group. A control may be applying some function for objects 110-1 and 110-2 to perform. For example, a command to play a football game or play a playlist of songs is applied to all objects 110 of group 202-1, and thus causes corresponding controllable devices 104-1 and 104-2 to start playing the football game or play the playlist.

The above gesture forms a new group; however, objects 110 may be moved into an already existing group 202. FIG. 2C shows an example where a user has used a gesture to move a first object 110-1 into an existing group 202-2 according to one embodiment. By providing a pinching gesture, first object 110-2 becomes part of group 202-2. As shown, first object 110-1 and group 202-2 are being touched by a user's two fingers. Group 202-2 includes other objects 104-n.

FIG. 2D shows a result of performing the object gesture of FIG. 2C according to one embodiment. As shown, objects 110-1 and 110-n have been grouped together in a group 202-2. In one embodiment, group 202-2 is associated with a control that causes controllable devices 104-1 and 104-n associated with objects 104-1 and 104-n, respectfully, to perform a function. For example, the function may be playing a football game. In this case, controllable devices 104-n may have already been playing the football game. When first object 110-1 is added to group 202-3, the control is applied to object 110-1. This causes a corresponding controllable device 104-1 to start playing the football game.

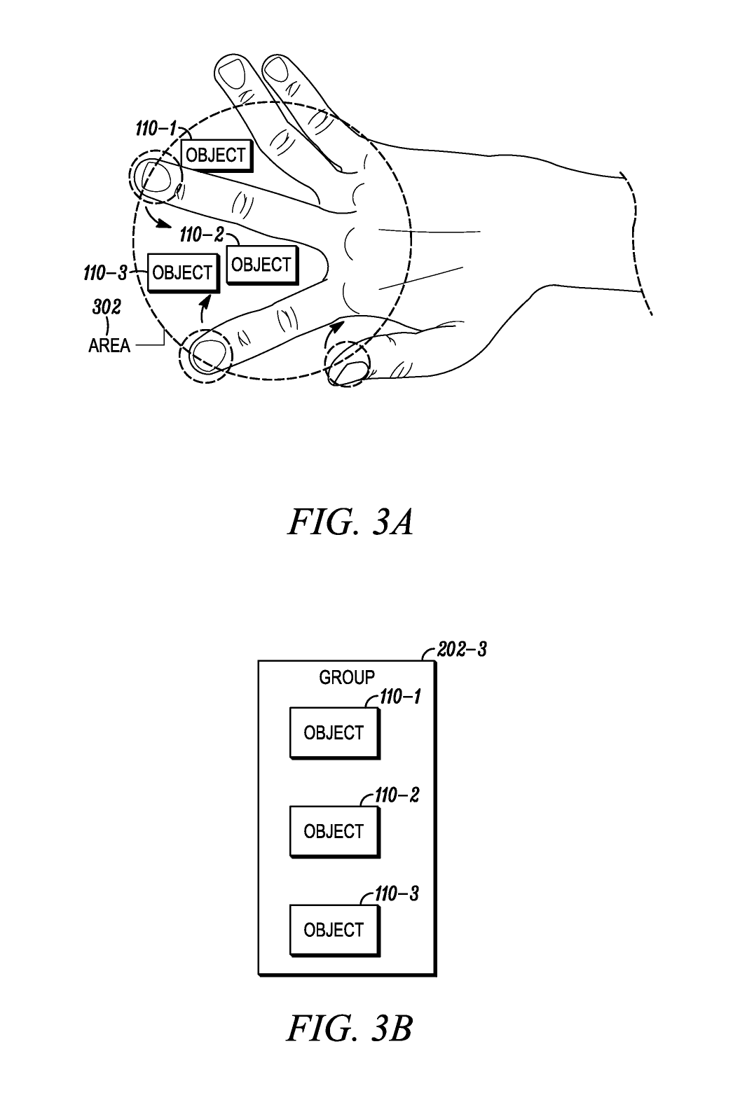

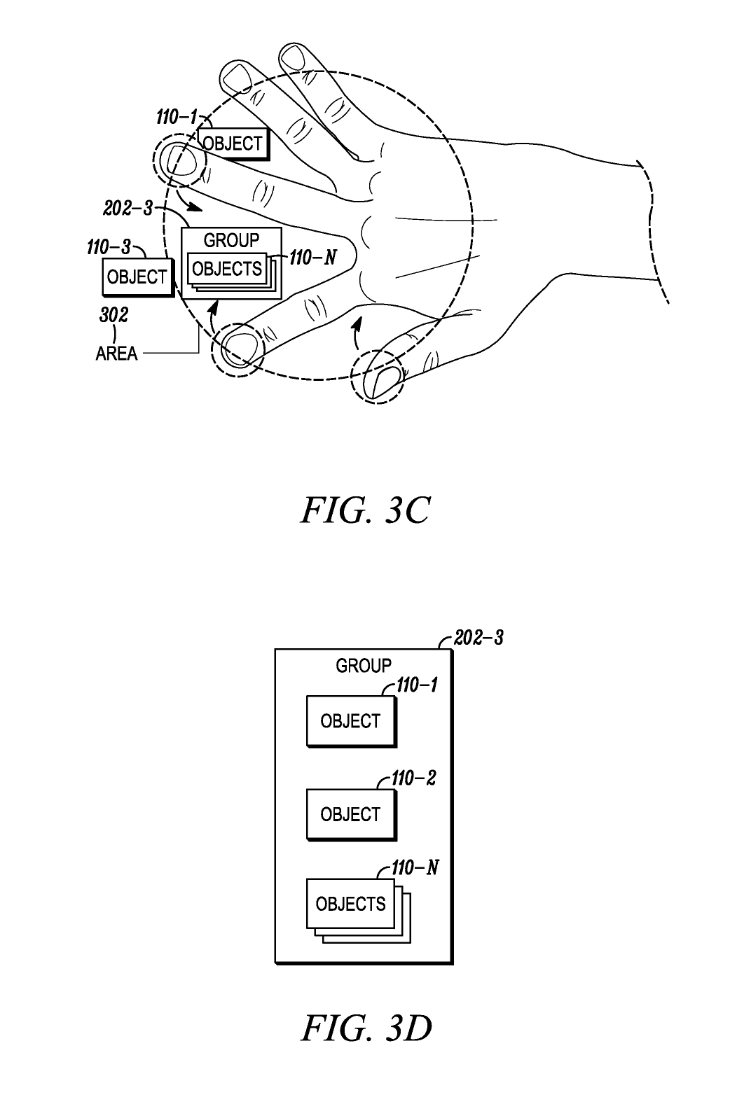

FIGS. 3A and 3B show another example of forming a group using an “area gesture” according to one embodiment. FIG. 3A shows an example where a user has used a multi-touch gesture to indicate an area in which objects 110 within the area should be grouped together according to one embodiment. In this example, a user uses three fingers to form the borders for the area. However, a user may also use more than three fingers to form the area.

As shown, an area 302 may be formed using the three areas of touch detected from the user's fingers on user interface 106. The areas of touch may or may not contact an object 110. Gesture control manager 108 may detect the touch and area 302 using known methods. Once area 302 is detected, gesture control manager 108 then determines objects 110 within the area. In this case, objects 110-1, 110-2, and 110-3 are found within area 302. The objects within the area may be objects that are totally within the area, objects partially within the area, or any objects that are within or partially within the area.

The user may indicate a desire to group objects 110-1-110-3 by pinching the three fingers together. As noted, the user does not need to contact objects 110 specifically to have them grouped. In other examples, the user may touch the screen with the three fingers and then also indicate the desire for grouping by pressing a separate button or icon to indicate the desire to create a group.

FIG. 3B depicts an example of a grouping that is created based on the area gesture received in FIG. 3A according to one embodiment. As shown, a group 202-3 has been created that includes objects 110-1, 110-2, and 110-3. Once again, objects 110-1-110-3 can be shown visually within a border. However, other methods of showing the grouping may also be used.

Once group 202-3 is created, gesture control manager 106 associated a control for the group that applies to all objects 110 of the group. For example, a command to play a football game or play a playlist of songs is applied to all objects 110 of group 202-3, and thus causes corresponding controllable devices 104-1, 104-2, and 104-3 to start playing the football game or play the playlist.

FIG. 3C shows an example where a user has used a gesture to move a first object 110-1 into an existing group 202-3 using the area gesture according to one embodiment. As shown, first object 110-1, second object 110-2, and group 202-3 are within an area defined by the user's three fingers. Group 202-3 includes other objects 110-n. By providing a pinching gesture for the area, first object 110-1 and second object 110-2 become part of group 202-3.

FIG. 3D shows a result of performing the object gesture according to one embodiment. As shown, objects 110-1, 110-2, and 110-n have been grouped together in a group 202-3. Controllable devices 104-1, 104-2, and 104-n now perform a same function.

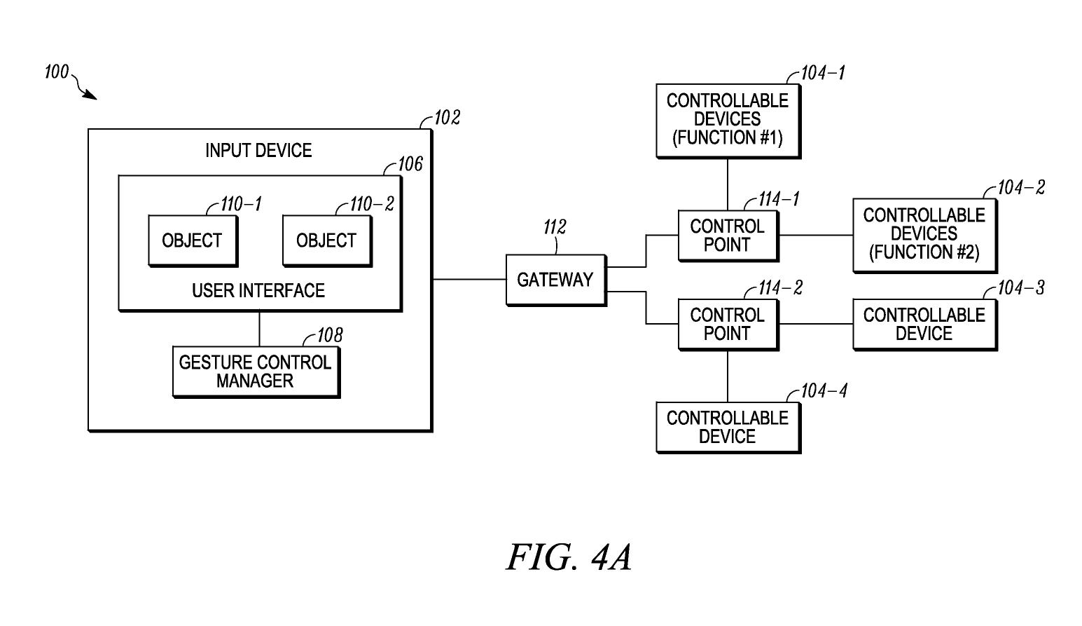

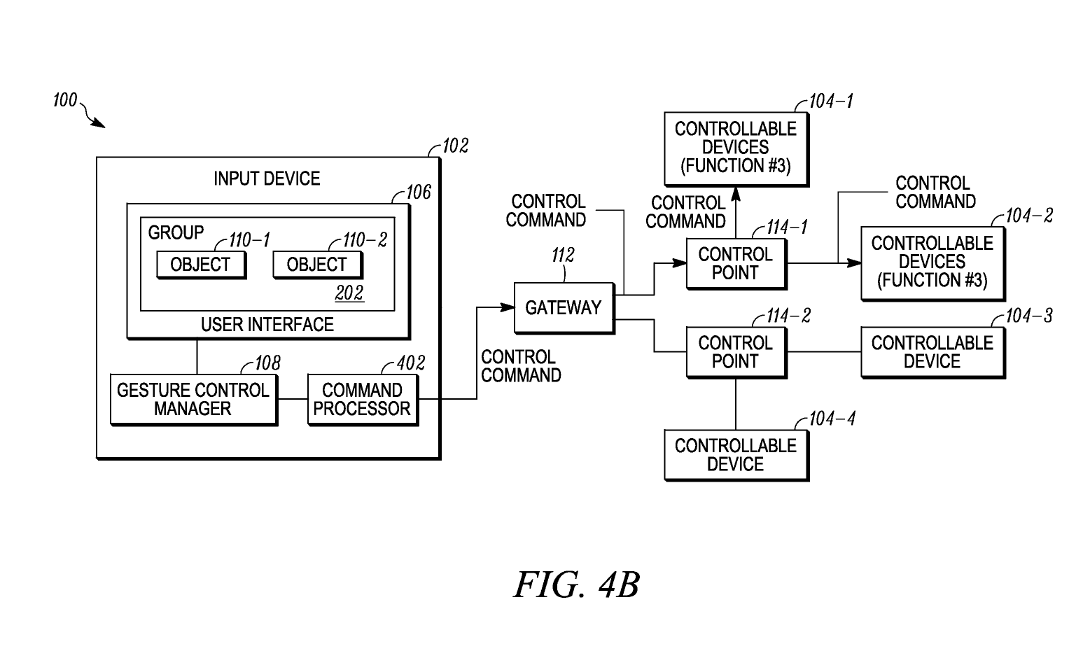

FIGS. 4A and 4B show a result of using a gesture to form a group 202 according to one embodiment. FIG. 4A shows an example of system 100 before forming group 202 according to one embodiment. As shown, objects 110-1 and 110-2 are not part of a group 202. Also, controllable devices 104-1 and 104-2 are performing separate functions—function #1 and function #2, respectively. For example, controllable device 104-1 may be playing a first playlist #1 and controllable device 104-2 may be playing a second playlist #2. Also, controllable devices 104-1 and 104-2 are individually controllable via objects 110-1 and 110-2, respectively.

FIG. 4B depicts an example for controlling devices when a group 202 is formed according to one embodiment. As shown, objects 110-1 and 110-2 are shown as being grouped in group 202 on interface 104. Also, controllable devices 104-1 and 104-2 now perform a single function associated with group 202—function #3. Function #3 may be playing a master playlist that includes a combination of playlists #1 and #2 or maybe one of playlist #1 or #2.

To cause controllable devices 104-1 and 104-2 to perform function #3, a command processor 402 may send a control command for group 202. For example, the command causes controllable devices 104-1 and 104-2 to play the master playlist. Command processor 402 receives a signal from gesture control manager 108 indicating a group has been formed. Command processor 402 determines a control to apply to the group and sends a command to control controllable devices 104-1 and 104-2.

Users may also control objects 110 within group 202 after forming the group. For example, a user may use interface 106 of any input device 102 to apply a control command to group 202. A command processor 402 detects the control command for group 202. Command processor 402 may then determine objects 110 that are included in group 202. For example, in this case, objects 110-1 and 110-2 are included in group 202. Command processor 402 then sends a command for corresponding controllable devices 104-1 and 104-2 for objects 110-1 and 110-2.

In one embodiment, gateway 112 receives the command and applies the command to controllable devices 104-1 and 104-2. For example, control point 114-1 receives a command for a controllable device 104-1. Control point 114-1 then applies the command to controllable devices 104-1 and 104-2. For example, controllable devices 104-1 and 104-2 may start playing the master playlist. Thus, both controllable devices 104-1 and 104-2 start playing the master playlist in response to the control command received for group 202.

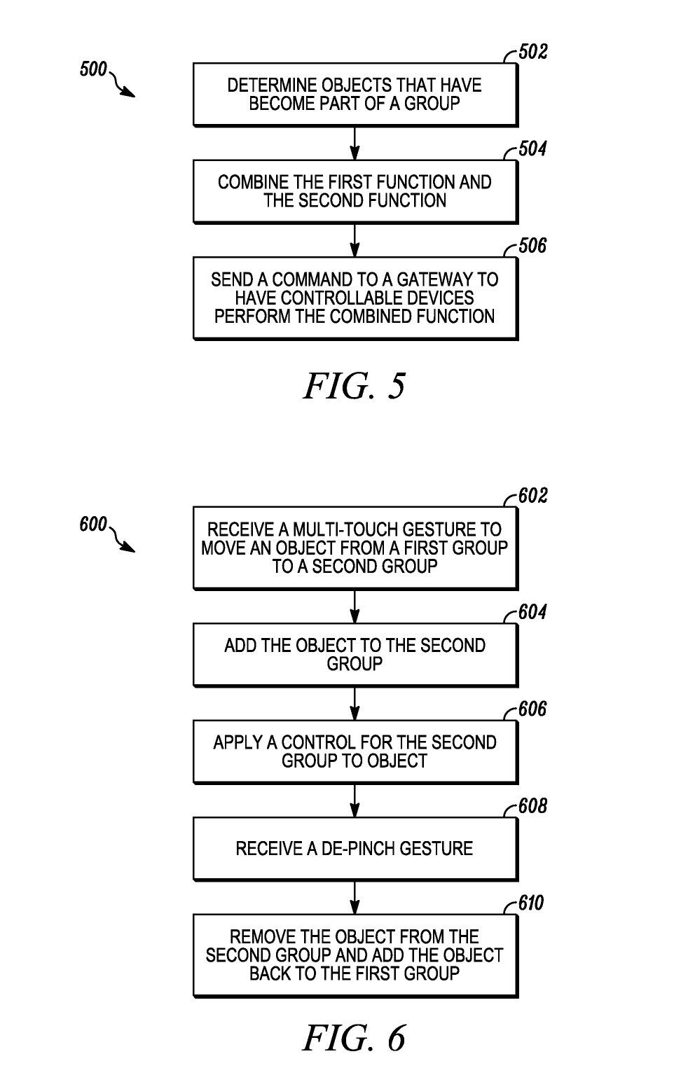

To illustrate the above, FIG. 5 depicts a simplified flowchart for combining functions according to one embodiment. In one example, when a group is formed, objects 110 may be performing different functions. In this case, the functions being performed may be combined within the group. For example, a first media player may be playing a first playlist and a second media player may be playing a second playlist. These playlists may then be combined. At 502, command processor 402 determines that objects 110-1 and 110-2 have become part of a group 202. Command processor 402 then determines a first function for object 110-1 and a second function for object 110-2. The functions may be current functions that are being performed by object 110-1 and object 110-2. As discussed above, objects 110-1 and 110-2 may be playing different playlists.

At 504, command processor 402 combines the first function and the second function. For example, command processor 402 combines the first playlist and the second playlist. The order of the songs within the playlist may vary. For example, command processor 402 may put songs in the first playlist first followed by songs in the second playlist. Alternatively, command processor 402 may interleave the songs from the first playlist and the second playlist.

At 506, command processor 402 sends a command to gateway 108 to have controllable devices 104-1 and 104-2 perform the combined function. For example, command processor 402 sends the new playlist to both controllable devices 104-1 and 104-2, which then start playing the new playlist.

If an existing group 202 has already been formed, when an object 110 is added to group 202, then command processor 402 generates a command to cause an added controllable device 104 to perform the function of group 202. For example, command processor generates a command to play a football game and automatically and sends the command to a controllable device 104.

When combining objects 110, a tiered structure may be used. For example, a user may move an object 110 from one group to another group using a multi-touch gesture. Then, when the user wants to remove object 110 from the second group, the user may use a de-pinch gesture and object 110 is reinserted back into the first group. FIG. 6 depicts a simplified flowchart of a method for performing grouping using tiers according to one embodiment.

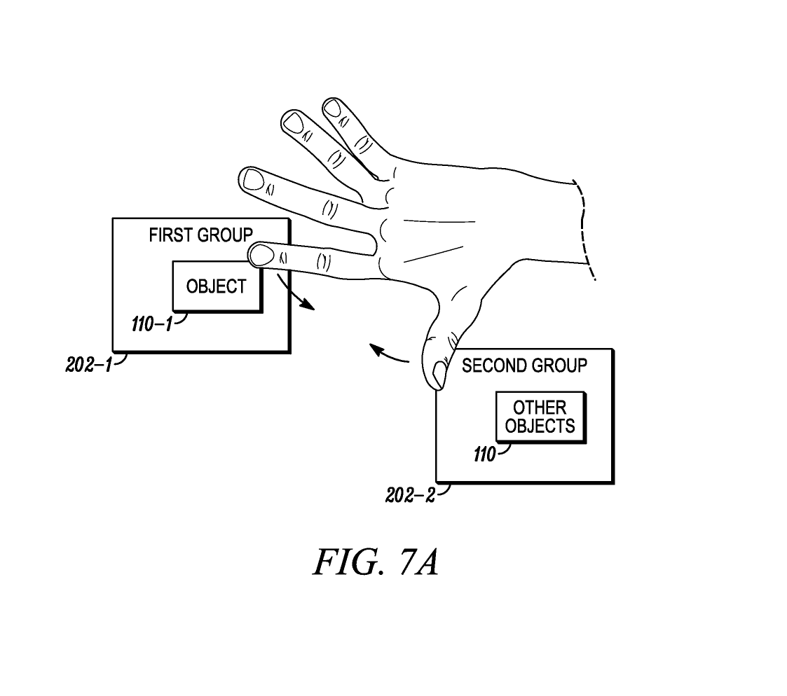

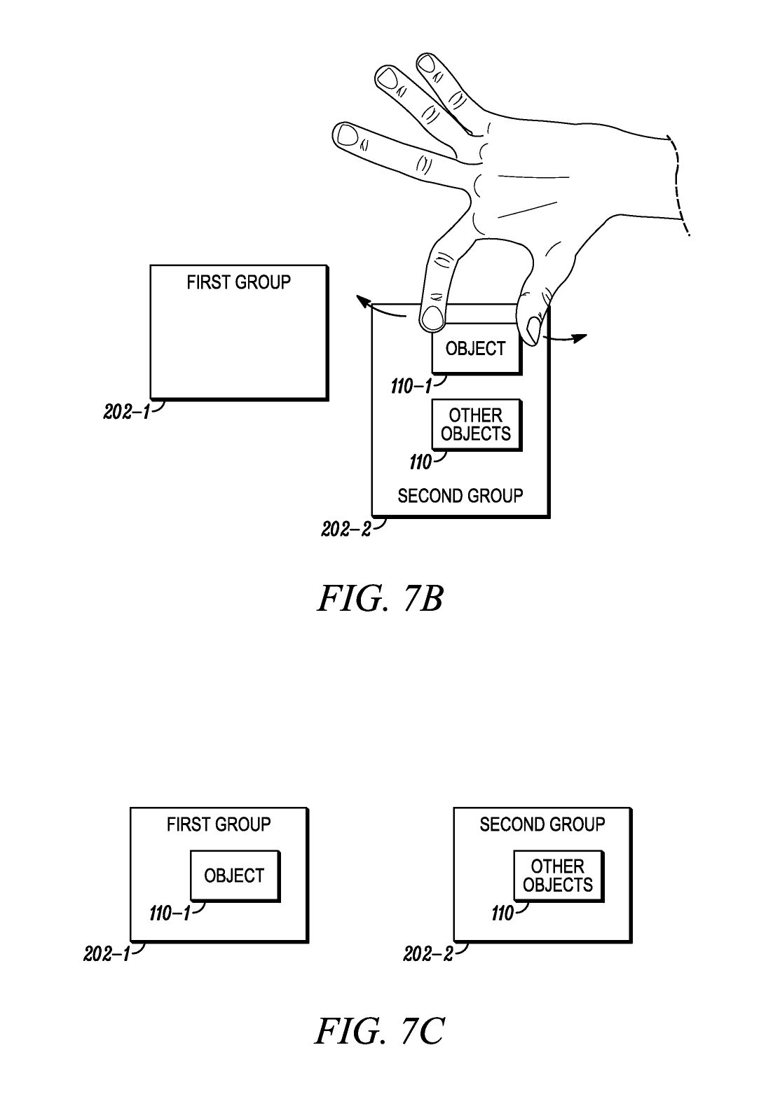

At 602, gesture control manager 108 receives a multi-touch gesture to move an object 110 from a first group 202-1 to a second group 202-2. For example, FIG. 7A shows an example of using a pinching gesture to move object 110-1 from a first group 202-1 to a second group 202-2 according to one embodiment. The user may use two fingers where one finger is on object 110-1 and another finger is on an object for the second group 202-2. The user then moves object 110-1 into the second group 202-2. At 604, gesture control manager 108 adds object 110-1 to the second group 202-2, which may also contain other objects 110. When object 110-1 is added to the second group 202-2, gesture control manager 108 creates a tiered structure. For example, the tiered structure may be “first group→second group”. In this case, the first group is a parent to the second group.

At 606, command processor 402 applies a control for the second group 202-2 to object 110-1. For example, a function associated with the second group is applied to object 110-1, such as a controllable device 104 associated with object 110-1 may start playing a football game that other controllable devices 104 in the second group are already playing.

At 608, gesture control manager 108 receives a de-pinch gesture. FIG. 7B shows an example of a de-pinch gesture according to one embodiment. For example, the user may use a finger to contact object 110-1 and second group 202-2, and remove object 110-1 from second group 202-2. In one example, the de-pinch speed may be used to graphically decelerate and position object 110-1 as the object 110-1 is moved apart from second group 202-2. At 610, when the de-pinch gesture occurs, gesture control manager 108 removes object 110-1 from second group 202-2 and adds object 110-1 back to the first group. FIG. 7C shows a result of the de-pinch gesture according to one embodiment. In this case, gesture control manager 108 may consult the tiered structure. Instead of removing object 110-1 to a position where it is not within any group, gesture control manager 108 determines a parent tier to second group 202-2, which is first group 202-1.

An example of using the tiered structure will now be described. In one example, a first group 202-1 may be designated as a baseball zone. A second group 202-2 may be designated as a football zone. Controllable devices 104 within first group 202-1 and second group 202-2 may be televisions. Each television may be interspersed within a location, such as a bar. At one point, a user that is watching a television may not want to watch a baseball game, but rather wants to watch a football game. In this case, a bartender may pinch an object 110-1 corresponding to the television from first group 202-1 into second group 202-2. This causes the television to automatically start playing a football game because it has been added to the football zone.

At some point, the user who wanted to watch the football game may leave the bar. At this point, the bartender may de-pinch object 110-1 from the second group 202-2. Gesture control manager 108 then automatically removes object 110-1 from second group 202-1 and places object 110-1 back within first group 202-1. In this case, the television starts playing the baseball game again.

Accordingly, particular embodiments allow users to use gestures to group objects together. Then, control commands may be applied to the group. This provides a convenient way for users to control multiple controllable devices 104 together. For example, once a group is formed, control commands from any input device 102 may be applied to the group. For example, a first input device 102 groups two audio zones to play the same song using a multi-touch gesture. At that point, commands (from any input device 102) to one of the audio zones is echoed to the other audio zone. Another example is when a first input device groups multiple televisions into the same group, such as in a sports bar. Then, any control command by any input device 102 performed on the group is echoed to all controllable devices 104 in the group.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving a gesture via a touchscreen of an electronic device, the touchscreen displaying a set of objects that are used to control a set of controllable devices;
determining the gesture is a command to group a plurality of objects together;
joining the plurality of objects as a single group, wherein the plurality of objects correspond to a plurality of controllable devices; and
associating a control to apply to the single group in response to receiving the gesture, wherein the control is applied to the plurality of controllable devices to cause the plurality of controllable devices to perform a function together.

2. The method of claim 1, wherein the gesture is an item gesture, wherein the item gesture touches the plurality of objects on the touchscreen.

3. The method of claim 1, wherein the gesture is an area gesture, wherein the area gesture touches an area that includes the plurality of objects on the touchscreen.

4. The method of claim 1, wherein the gesture is a pinching movement.

5. The method of claim 1, wherein the gesture is a multi-touch gesture.

6. The method of claim 1, wherein:
a first controllable device is performing a first function; and
a second controllable device is performing a second function,
wherein the first controllable device and the second controllable device perform one of the first function, the second function, or a third function based on being joined as the single group.

7. The method of claim 1, further comprising:
receiving a command associated with the single group; and
applying the command to control the plurality of controllable devices associated with the plurality of objects in the single group.

8. The method of claim 1, wherein:
a first object in the plurality of objects is added into the single group via the gesture;
determining the control associated with the single group, wherein objects already within the group are associated with the control; and
applying the control to a first controllable device associated with the first object in response to the first object being added into the single group.

9. The method of claim 1, wherein the gesture comprises a first gesture, the method further comprising:
receiving a second gesture to unjoin at least one of the plurality of objects from the single group; and
removing the at least one of the plurality of controllable devices from the single group.

10. The method of claim 9, wherein removing the at least one of the plurality of controllable devices comprises returning the at least one of the plurality of controllable devices to a previous group the at least one of the plurality of controllable devices was a member of prior to being joined in the single controllable device group.

11. A non-transitory computer-readable storage medium containing instructions that, when executed, control a computer system to be configured for:
receiving a gesture via a touchscreen of an electronic device, the touchscreen displaying a set of objects that are used to control a set of controllable devices;
determining the gesture is a command to group a plurality of objects together;
joining the plurality of objects as a single group, wherein the plurality of objects correspond to a plurality of controllable devices; and
associating a control to apply to the single group in response to receiving the gesture, wherein the control is applied to the plurality of controllable devices to cause the plurality of controllable devices to perform a function together.

12. The non-transitory computer-readable storage medium of claim 11, wherein the gesture is an item gesture, wherein the item gesture touches the plurality of objects on the touchscreen.

13. The non-transitory computer-readable storage medium of claim 11, wherein the gesture is an area gesture, wherein the area gesture touches an area that includes the plurality of objects on the touchscreen.

14. The non-transitory computer-readable storage medium of claim 11, wherein the gesture is a pinching movement.

15. The non-transitory computer-readable storage medium of claim 11, wherein the gesture is a multi-touch gesture.

16. The non-transitory computer-readable storage medium of claim 11, wherein:
a first controllable device is performing a first function; and
a second controllable device is performing a second function,
wherein the first controllable device and the second controllable device perform one of the first function, the second function, or a third function based on being joined as the single group.

17. The non-transitory computer-readable storage medium of claim 11, further comprising:
receiving a command associated with the single group; and
applying the command to control the plurality of controllable devices associated with the plurality of objects in the single group.

18. The non-transitory computer-readable storage medium of claim 11, wherein:
a first object in the plurality of objects is added into the single group via the gesture;
determining the control associated with the single group, wherein objects already within the group are associated with the control; and
applying the control to a first controllable device associated with the first object in response to the first object being added into the single group.

19. The non-transitory computer-readable storage medium of claim 11, wherein the gesture comprises a first gesture, the method further comprising:
receiving a second gesture to unjoin at least one of the plurality of objects from the single group; and
removing the at least one of the plurality of controllable devices from the single group.

20. A system comprising:
a plurality of controllable devices, wherein the plurality of controllable devices correspond to a set of objects that are used to control the plurality of controllable devices via a touchscreen of an input device; and
a control device coupled to the plurality of controllable devices, wherein:
a set of controllable devices are grouped together into a single group based on a gesture received via the touchscreen the input device, the touchscreen displaying the set of objects,
the control device receives a control to apply to the single group in response to the gesture, and
the control device applies the control to the plurality of controllable devices to cause the plurality of controllable devices to perform a function together.
